(19) United States
(12) Patent Application Publication
(10) Pub. No.: US 2009/0127470 A1
(43) Pub. Date: May 21, 2009

(54) FLAT PANEL DETECTOR WITH TEMPERATURE SENSOR

(76) Inventor: Mathias Hoernig, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 12/271,129

(22) Filed: Nov. 14, 2008

(30) Foreign Application Priority Data
Nov. 16, 2007 (DE) 10 2007 054 832.1

(51) Int. Cl. G01T 1/24; G01K 3/00

(52) U.S. Cl. 250/370.09; 374/137; 374/E03.001

(57) ABSTRACT

A flat panel detector for x-ray radiation has at least one radiation sensor and at least one temperature sensor. The radiation sensor is composed of a number of radiation sensor elements. The temperature sensor is of laminar design, and its surface is approximately equal in size to the surface of the radiation sensor. The temperature sensor can be formed by a number of temperature sensor elements. The current temperature of each pixel of the radiation sensor thus can be determined.

### BACKGROUND OF THE INVENTION

1. Field of the Invention

The invention concerns a flat panel detector for x-ray radiation.

2. Description of the Prior Art

In modern x-ray imaging, flat panel detectors (also called solid state detectors) are known that directly deliver an x-ray image in digital form. Two types of flat panel detectors are differentiated: indirect and direct.

In an indirect flat panel detector, the incident x-ray radiation is converted by means of a scintillator into visible light. A semiconductor (normally made of amorphous silicon) from which an integrated circuit for transduction of the visible light into electrical signals is formed is located below the scintillator. There is one capacitor, one thin film transistor (also called a TFT) and one photodiode per pixel. The photodiode transduces the visible light into electrons. The capacitor stores this charge, and the pixel can be read out with the aid of the thin film transistor.

Instead of a scintillator and a photodiode, direct flat panel detectors use a photoconductor that is sensitive to x-ray radiation that generates electrical charges upon being struck by photons. These charges are drawn off with electrodes. The photocathode typically is composed of amorphous selenium, which exhibits a high sensitivity to x-ray radiation as well as a very good spatial resolution. An electrical field is applied to a selenium layer. Holes and electrons that diffuse in the direction of the applied field arise due to the x-ray radiation. The evaluation electronics are of similar design to those of the indirect flat panel detectors described above.

Thermal influences can disruptively affect the image acquisition both in indirect and direct flat panel detectors. These temperature-dependent x-ray sensitivity variations occur at the adhesion edges of the individual radiation sensors, not only in large-area flat panel detectors but even in flat panel detectors of a size of approximately 20×20 cm², when local heat sources (for example electrical modules on a circuit board) are located under the radiation sensor. The local temperature differences created in this manner lead to different dark currents, electrical noise and a rise of the ghost image response, thus to a degradation of the x-ray image quality.

Therefore, flat panel detectors normally have temperature sensors that are arranged near the radiation sensor. DE 101 08 430 A1 describes how such a temperature sensor is arranged and how the temperature value measured thereby can be used to detect errors and/or a deterioration aging of a radiation sensor chip.

### SUMMARY OF THE INVENTION

An object of the invention is to provide a flat panel detector with improved temperature value measurement.

According to the invention, this object is achieved by a flat panel detector having at least one temperature sensor of laminar design with a surface that is approximately equal in size to the surface of the radiation sensor, this laminar temperature sensor being arranged in a flat panel detector for x-ray radiation that have at least one radiation sensor with a number of radiation sensor elements.

The inventive flat panel detector provides the advantage that a precise temperature indication is possible for every point of the radiation sensor. An additional advantage is that temperature fluctuations and the formation of a temperature gradient for the entire radiation sensor can be detected.

In an embodiment, the temperature sensor can be arranged below the radiation sensor and can be involved in an active connection therewith.

It is then advantageous that local effects of heat rays can be detected below the radiation sensor and can be compensated by suitable measures. Temperature-dependent artifacts (for example ghost images and noise) thus can be prevented or reduced.

In a further embodiment, the temperature sensor can be integrated into the radiation sensor.

A simple and cost-effective production is thereby possible.

In an embodiment of the invention, the temperature sensor can be formed by a number of temperature sensor elements.

It is then advantageous that the temperature distribution can be retrieved for a specific pixel at any time and can be associated with pixel-related image information.

In a further embodiment, each temperature sensor element can be a temperature-dependent semiconductor resistor (spreading resistance).

This has the advantage that proven semiconductor technologies can be used for production.

In another embodiment, exactly one temperature sensor element is associated with each radiation sensor element.

This has the advantage of a pixel-specific temperature measurement.

In a further embodiment, one temperature sensor element is associated with four radiation sensor elements.

The arrangement can be executed more simply with sufficiently good resolution of the temperature distribution.

In another embodiment, the radiation sensor directly convert x-ray radiation into electrical charges (direct conversion).

An additional object of the invention is to provide an x-ray image acquisition unit.

According to the invention, this object is achieved by an x-ray image acquisition unit having a flat panel detector according to the invention, as described above.

### BRIEF DESCRIPTION OF THE DRAWINGS

FIG. 1 schematically illustrates a conventional flat panel detector.

FIG. 2 is a section view of a radiation sensor for direct conversion, in accordance with the invention.

FIG. 3 is a section view of a radiation sensor for indirect conversion in accordance with the invention.

FIG. 4 is a section view of a radiation sensor element and a temperature sensor element in accordance with the invention.

### DESCRIPTION OF THE PREFERRED EMBODIMENTS

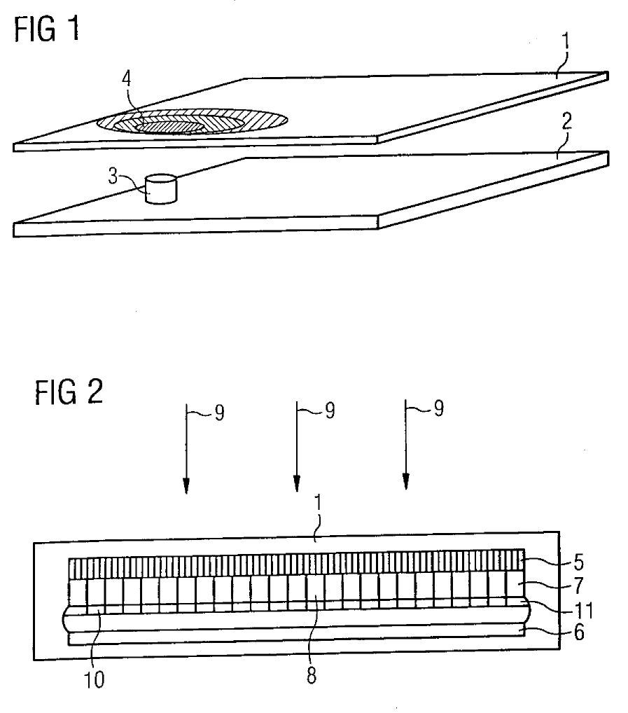

FIG. 1 shows a flat panel detector 1 in the form of a plate. Arranged below is a circuit board 2, for example an analog board with electronic modules (not presented in detail). The flat panel detector 1 is locally heated in the region 4 (identified in FIG. 1) by a heat-emitting module 3. Spatially different temperature distributions result on the flat panel detector, which can lead to different dark currents, electrical noise and an increase of the ghost image response. The image quality of an x-ray image exposure thereby degrades. Measures to detect the temperature distribution are required for prevention.

FIG. 2 shows a flat panel detector according to the invention which contains: a scintillator layer 5 as an indirect converter of an incident x-ray radiation 9; an evaluation electronic 6; and an active matrix (what is known as a radiation sensor 7) composed of a number of radiation sensor elements 8 arranged in a matrix. The radiation sensor elements 8 respectively contain at least one photodiode, a buffer element in the form of a memory capacitor, and an intermediate circuit element in the form of a transfer transistor.

A laminar temperature sensor 11 formed by a number of temperature sensor elements 10 is arranged below the radiation sensor 7. The temperature measurement of the temperature sensor elements 10 is based on the temperature-dependency of the specific resistance of doped silicon. The design of the temperature sensor elements 10 ensues either as a compact silicon block or as a spreading resistance. Details in this regard are reproduced in FIG. 4.

With the use of the temperature sensor elements 10, it is possible to precisely detect the resistances and thus the temperatures up to the pixel level. For example, these can be transmitted upon request or automatically to the evaluation unit of an x-ray image acquisition system with every item of image pixel information (for example as a 16th bit). Alternatively, the transmission can ensue only with the offset or dark images.

If a critical temperature at the radiation sensor 7 is achieved, a new gain image or a new offset image can be requested, the intensity of the backlight on a backlight board can be adapted to the local temperature distribution, or the temperature change can be compensated via a resistance heating on or below the radiation sensor 7.

The evaluation electronic 6 is designed with thin film transistors (TFTs) in a thin film technique.

The scintillator layer 5 is made of cesium iodide, for example; the radiation sensor 7 and the temperature sensor 11 are preferably composed of amorphous silicon.

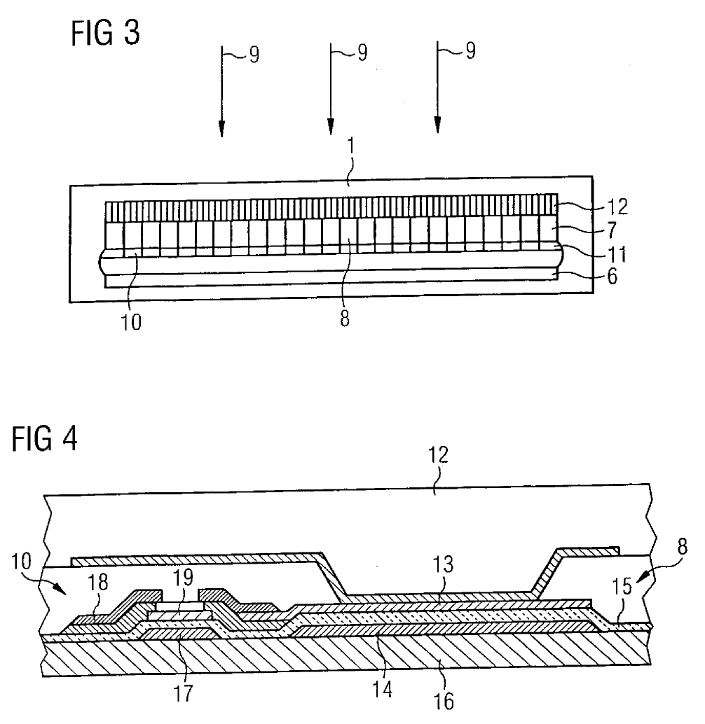

FIG. 3 shows a flat panel detector 1 with direct conversion of the incident x-ray radiation 9. The x-ray radiation 9 is directly converted into electrical charges in a converter layer 12 (for example made of amorphous selenium). This charge is stored by the radiation sensor elements 8 of the radiation sensor 7 and transmitted to the evaluation electronic 6. The radiation sensor elements 6 respectively contain at least one buffer element in the form of a storage capacitor and an intermediate circuit element in the form of a transfer transistor. The temperature sensor 11 is arranged below the radiation sensor 7 (similar to FIG. 2) and is comparably made up of temperature sensor elements 10.

The temperature sensor 11 is advantageously integrated into the radiation sensor 7, or forms a unit therewith. FIG. 4 shows a design in this regard in detail. A radiation sensor element 8 is presented which comprises a converter layer 12 made from amorphous selenium and electrodes 13, 14. A dielectric 15 is located between the electrodes 13, 14. The radiation sensor element 8 is arranged on a glass substrate.

A temperature sensor element 10 is arranged on the glass substrate 16 in immediate proximity to the radiation sensor element 8. The temperature sensor element 10 consists of the electrodes 17, 18 between which are located the dielectric 15 and a semiconductor layer 19 (made of amorphous silicon, for example). The semiconductor layer 19 forms the resistance area whose resistance changes depending on the temperature. The temperature in the immediate proximity of the radiation sensor element 8 can thus be determined by measuring the resistance between the two electrodes 17, 18. The design and functioning of these temperature sensor elements, known as spreading resistance temperature sensor elements, are described in detail in DE 101 36 005 C1.

In an additional embodiment, one temperature sensor element 10 can be provided for multiple (for example four) radiation sensor elements 8.

Although modifications and changes may be suggested by those skilled in the art, it is the intention of the inventor to embody within the patent warranted hereon all changes and modifications as reasonably and properly come within the scope of his contribution to the art.

I claim as my invention:

1. A flat panel detector for x-ray radiation comprising:
at least one radiation sensor comprised of a plurality of radiation sensor elements, said radiation sensor having a surface; and
a temperature sensor having a laminar configuration and having a surface approximately equal in size to the surface of the radiation sensor.

2. A flat panel detector as claimed in claim 1 wherein said temperature sensor is located beneath said radiation sensor and is actively connected thereto.

3. A flat panel detector as claimed in claim 1 wherein said temperature sensor is integrated into said radiation sensor.

4. A flat panel detector as claimed in claim 1 wherein said temperature sensor comprises a plurality of temperature sensor elements.

5. A flat panel detector as claimed in claim 4 wherein each temperature sensor element comprises a temperature-dependent semiconductor resistor.

6. A flat panel detector as claimed in claim 4 wherein said temperature sensor elements are respectively associated with said radiation sensor elements on a one-to-one basis.

7. A flat panel detector as claimed in claim 4 wherein each temperature sensor element is respectively associated four of said radiation sensor elements.

8. A flat panel detector as claimed in claim 1 wherein each of said temperature sensor elements generates a temperature measurement value and wherein each radiation sensor element emits a radiation sensor element output, and comprising a correction unit that corrects the respective radiation sensor element outputs dependent on said temperature measurement values.

9. A flat panel detector as claimed in claim 1 wherein said radiation sensor directly converts x-ray radiation incident therein into electrical charges.

10. An x-ray image acquisition system comprising:
an x-ray source that emits x-ray radiation; and
a flat panel detector that detects said x-ray radiation, said flat panel detector comprising at least one radiation sensor comprised of a plurality of radiation sensor elements, said radiation sensor having a surface, and a temperature sensor having a laminar configuration and having a surface approximately equal in size to the surface of the radiation sensor.
